(19) United States
(12) Patent Application Publication
(10) Pub. No.: US 2010/0169457 A1
(43) Pub. Date: Jul. 1, 2010

(54) SOCIAL USER SCRIPT SERVICE BY SERVICE PROXY

(75) Inventors: Takafumi Kinoshita, Tokyo (JP); Eizo Tsukada, Tokyo (JP)

Correspondence Address: SCULLY, SCOTT, MURPHY & PRESSER, P.C., 400 GARDEN CITY PLAZA, SUITE 300, GARDEN CITY, NY, 11530, US

(73) Assignee: INTERNATIONAL BUSINESS MACHINES CORPORATION, Armonk, NY (US)

(21) Appl. No.: 12/344,336

(22) Filed: Dec. 26, 2008

(51) Int. Cl. G06F 17/00; G06F 15/16

(52) U.S. Cl. 709/219; 715/234

(57) ABSTRACT

Social user script service by service proxy receives a request from a user for an electronic document, and selects one or more user scripts from the plurality of user scripts that are authored by an experienced user and stored. The selected user scripts are embedded into the requested electronic document and transmitted to the user. The service proxy selects the user scripts to embed based on the user registration information.

### FIELD OF THE INVENTION

The present disclosure relates generally to computer systems, and more particularly to social user script service by service proxy.

### BACKGROUND OF THE INVENTION

A user script such as a JavaScript is written by a user. User script is administered and executed by a plug-in of a browser installed into the browser. Users can easily customize Web pages such as changing background colors and fonts and adding convenient links by designating to apply user scripts with an administration plug-in for Web pages of the site users are browsing. Because the size of functions that user scripts offer is small (situational applications), they may not be easily and effectively used or adapted for usage under a construction and activity form of an existing open source community. As Web 2.0 progresses in the future, it is considered that users themselves will increasingly prepare user scripts and customize as they like as they browse offered Web pages in their current state.

While users can write user scripts from scratch, many users opt to obtain previously written scripts from the Internet or like, and use those scripts as they are written without further modifications by the users. Presently, however, there is no reliable site that distributes safe user scripts, much less a technique established for distributing safe scripts. Consequently, users have no assurance for the safety of the obtained user scripts and the users are left with the risk that the security of their system may be compromised in using those scripts.

System developers and web content builders are continuously changing their content, for example, for reasons of business or otherwise. Due to such dynamic settings, e.g., due to the changes of Web sites or the contents such as Web pages, user scripts may no longer work correctly, and users need to change some portions of the scripts in order for the script to be compatible with the changes made in the Web or Web content such as Web pages. Understanding the logic of user script written by another person and modifying it present complex and troublesome tasks for the typical users who are not user script developers. It is also difficult to deal with dynamically prepared Web content. When a plurality of user scripts is incorporated into the processed Web page by proxy server, desired results are not always obtained due to interactions of the plurality of user scripts. For example, if one user script is to change an attribute of Web content, such as color, size of character, but another user script removes that attribute all together, the changes would not happen as expected.

While each individual web sites providing web content may maintain the services of also updating and/or enhancing the scripts or content, that would require skills of many IT persons and may prove to be costly.

### BRIEF SUMMARY OF THE INVENTION

A system and method for social user script service by service proxy are provided. The method, in one aspect, may include storing a plurality of user scripts, receiving a request from a user for an electronic document, and selecting based on one or more criteria one or more user scripts from the plurality of user scripts and one or more conditions under which said one or more user scripts are executed. The method may also include embedding said one or more selected user scripts into a requested electronic document, and transmitting the requested electronic document with the embedded user scripts to the user.

A system for social user script service by service proxy, in one aspect, may include a storage device storing a plurality of user scripts and user registration information and a service proxy processor operable to receive a request from a user for an electronic document and to selecting one or more user scripts from the plurality of user scripts based on the user registration information. The service proxy processor may be further operable to embed said one or more selected user scripts into a requested electronic document and transmit the requested electronic document with the embedded user scripts to the user.

A program storage device readable by a machine, tangibly embodying a program of instructions executable by the machine to perform methods described herein may be also provided.

Further features as well as the structure and operation of various embodiments are described in detail below with reference to the accompanying drawings. In the drawings, like reference numbers indicate identical or functionally similar elements.

### BRIEF DESCRIPTION OF THE DRAWINGS

FIG. 1 is a diagram illustrating service proxy server of the present disclosure and a use scenario in one embodiment.

FIGS. 2A, 2B, 2C and 2D illustrate examples of different scripts.

FIG. 3 illustrates applying user scripts automatically and/or selecting user scripts.

FIG. 4 is a diagram illustrating processing feedback of failure from users in one embodiment of the present disclosure.

FIG. 5 is a diagram illustrating notification process for occurrence of failure to supporters in one embodiment of the present disclosure.

FIG. 6 is a diagram illustrating notification process for updated information to supporters in one embodiment of the present disclosure.

FIG. 7 is a diagram illustrating information administered by the proxy server in one embodiment of the present disclosure.

FIG. 8 is a flow diagram illustrating a method for registering using user scripts.

FIG. 9 is a flow diagram illustrating processing failures in user scripts.

FIG. 10 illustrates an example of a computer system architecture in which the system and methods of the present disclosure may be carried out.

### DETAILED DESCRIPTION

The present application discloses providing user script service. For example, a proxy service may store a plurality of user scripts that are safe and up to date, and provide them automatically to the users as requested, needed or desired. The user scripts provided by the proxy service are up to date and authenticated. Beginner programmers or web users do not have to concern themselves about settings and/or safety of downloading those scripts because the settings of skilled users are already coded in the proxy service provided user scripts. These proxy-services provided user scripts of the present disclosure also have settings automatically updated according to content and external changes.

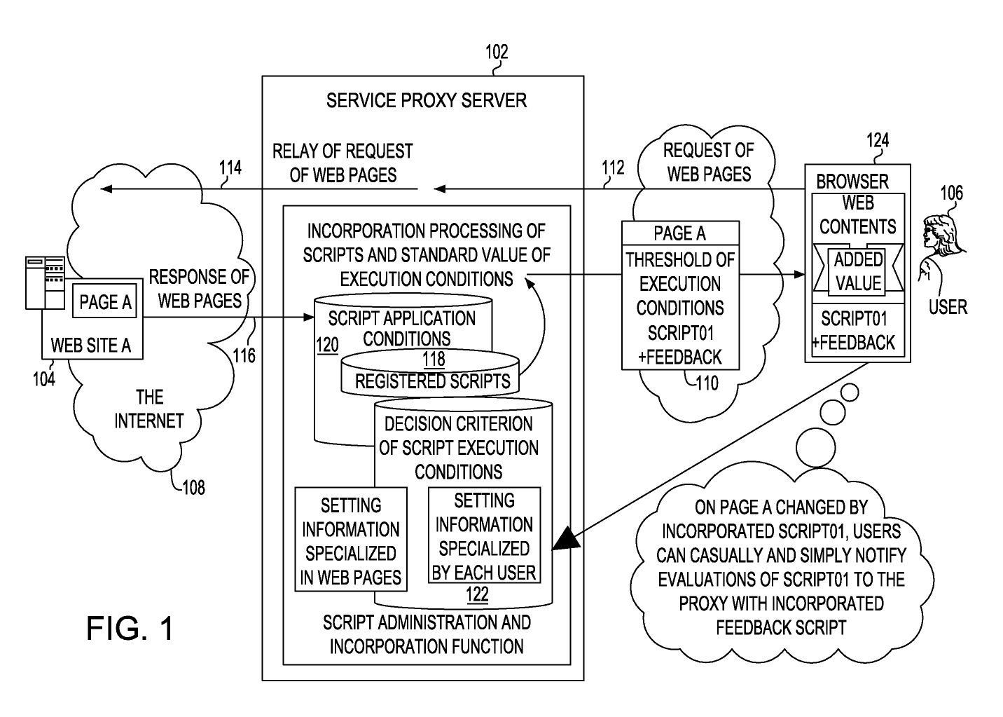

In one embodiment, a proxy server administers and executes the user scripts and users' setting information. FIG. 1 is a diagram illustrating service proxy server of the present disclosure and a use scenario in one embodiment. Users 106 access the Internet 108 via a proxy server 102, for example, in an administration site. When a user 106, for example, an inexperienced user, accesses a web site 104 via the proxy 102, public setting information of skilled users is automatically used, so that the same effect can be obtained without the knowledge of skilled users. When the users have registered user scripts for the accessed site, the Proxy server 102 sends Web pages incorporating user scripts 110 to the users 106. For example, an ISP operates a user-script administration site to offer safe user scripts to the users. There are user scripts developed and offered by the ISP and those developed by users and are disclosed by the ISP upon checking their safety. Users can freely choose them at the administration site. Proxy 102 incorporates various user scripts and setting information into Web pages. In this disclosure, the terms “incorporate”, “apply”, “applying”, “embed” or “embedding” of script(s) to Web pages refer to putting the script(s) in the web pages. Thus, for example, a service proxy may put the registered user script(s) in the web page, for instance, such that a browser rendering that web page would also cause the user script(s) to be executed.

In another aspect, user script services may be offered to match with users' preferences and level of skill. Since all access goes through the proxy, various services become possible based on users' profiling information (such as what kind of sites they access, what kind of user scripts they use, what kind of feedback they perform). For example, for beginner users, user scripts are automatically incorporated when browsing Web sites. Disclosed setting information of skilled users having similar preference is automatically employed. Since activities such as update of settings, feedback, and maintenance of scripts can be monitored, it is possible to know the level of the user's skill.

Yet in another aspect, the proxy service may offer workflow as means of navigating quick solutions for problems, the state of its implementation can be monitored, and the change results can be instantly reflected to usage of users. Development by multiple supporters in a short period, expansion of scope of application, and continuous improvement of user-friendliness are possible.

Condition values used in a script code is made to be configurable for each user and execution results of scripts can be changed, for example, not by modifying scripts but by changing settings by dynamically judging parameter values of the setting based on users' activities that are subjected to profiling by the proxy. The proxy server administers scripts and settings based on user preferences and attributes.

The user 106 requests a web page as shown at 112 and the proxy server 102 relays the web page request as shown at 114 to the appropriate web site 104 via the Internet 108. The web site 104 responds with the web page as shown at 116. The proxy server 102 receives the web page and incorporates scripts and standard value of execution conditions. For instance, previously user registered scripts 118, script application conditions 120, and/or decision criterion of script execution conditions 122 may be used to modify the web page returned from the web site.

The service proxy may store script application conditions 120 and decision criterion of script execution conditions 122. The script application conditions 120 may include information about whether each registered script should be applied to the processing web page in the proxy service. The proxy may compare the information about the processing web page to decide whether the proxy service combines a script into the processing web page. The decision criterion of script execution conditions 122 may include information about whether each script should be executed or how it should be executed with the downloaded web page in the browser.

For example, assume there is Web site providing news of stock market and the news in it is summary without stock chart. Also assume there is a user script that adds stock chart into Web content. The script application conditions 120 can contain the URL of a stock market new site. That news site can be registered to the user script. Briefly, registering may be done by linking or mapping the news site and the user script to one another, by any known or will be known method, e.g., using tables, objects or any other structures. If the user or browser requested Web site URL matches the registered URL, then the user script is applied to the web page, otherwise the web page is passed to the browser without any changes.

As an example, the decision criterion of script execution conditions 122 can contain one or more symbols and prices of some stocks in which the user has interest. The user script incorporated into the web page may be then executed based on those conditions, e.g., that the one or more stocks identified by the symbols are priced at the prices specified in the decision criterion of script execution conditions 122. Thus, for example, the user script adds the stock price chart in the web page only when the stock price has moved into the configured price range as specified in the registered values in 122.

The web page with incorporated scripts 110 are then transmitted to the user 106. In the rendered web page 124, the user 106 is presented with the original web content as returned from the web site 104, added value or information as a result of executing the scripts incorporated by the proxy server 102 and additional information for enabling the user to send feedbacks to the proxy server 102. For instance, on the web page changed by the incorporated script or scripts, the user can notify evaluations of the script to the proxy 102 with incorporated feedback script.

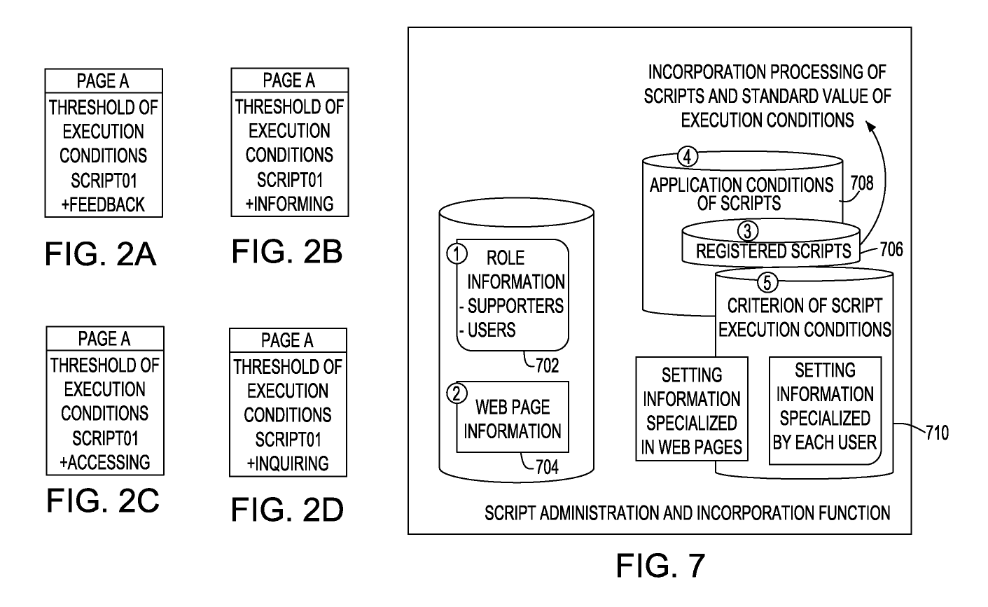

In one embodiment, the proxy server 102 incorporates different scripts in response to conditions. FIGS. 2A, 2B, 2C and 2D illustrate examples of different scripts. FIG. 2A illustrates a script that provides schematics for facilitating feedback from users. Such scripts may include language or instructions for having users notify information on failure. An example operation of such scripts may be:
usually, an icon-like button shape is clicked by users when notifying;
a summary of the kinds of failure is shown and users are asked to select;
destination universal resource locator (URL) information is obtained as information needed for recreating failure conditions and notifying it to the proxy server along with selected failure information.

FIG. 2B illustrates a script that includes schematics to enable quick response based on feedback from users. Scripts for notification are incorporated that failure is notified from users to supporters or users developing and maintaining scripts. An example operation of such scripts may be:
usually, an icon-like button shape shows that a failure of a script is reported;
when clicked by a supporter, a failure can be recreated by accessing the destination URL where the failure occurred;

FIG. 2C illustrates a script that includes links for accessing a page. At the time of recreation, scripts are incorporated that show links for accessing a page to update scripts and setting information by the proxy server. An example operation of such scripts may be:
usually, an icon-like button shape is clicked by a developer and it is possible to move to a page to update scripts and setting information;

FIG. 2D illustrates a script that includes a scheme to increase the number of sites where scripts are available and to secure quality. These scripts may be incorporated to help supporters maintain scripts and setting information. An example operation of such scripts may be:
usually, an icon-like button shape shows information such as whether there is any update of scripts and setting information;
when being clicked, detailed update information such as when, who, and how update is obtained from the proxy server is displayed.

The above-described and other scripts may be transmitted with a web page to the browser of users, and executed in the browser to help the users' to maintain the user script.

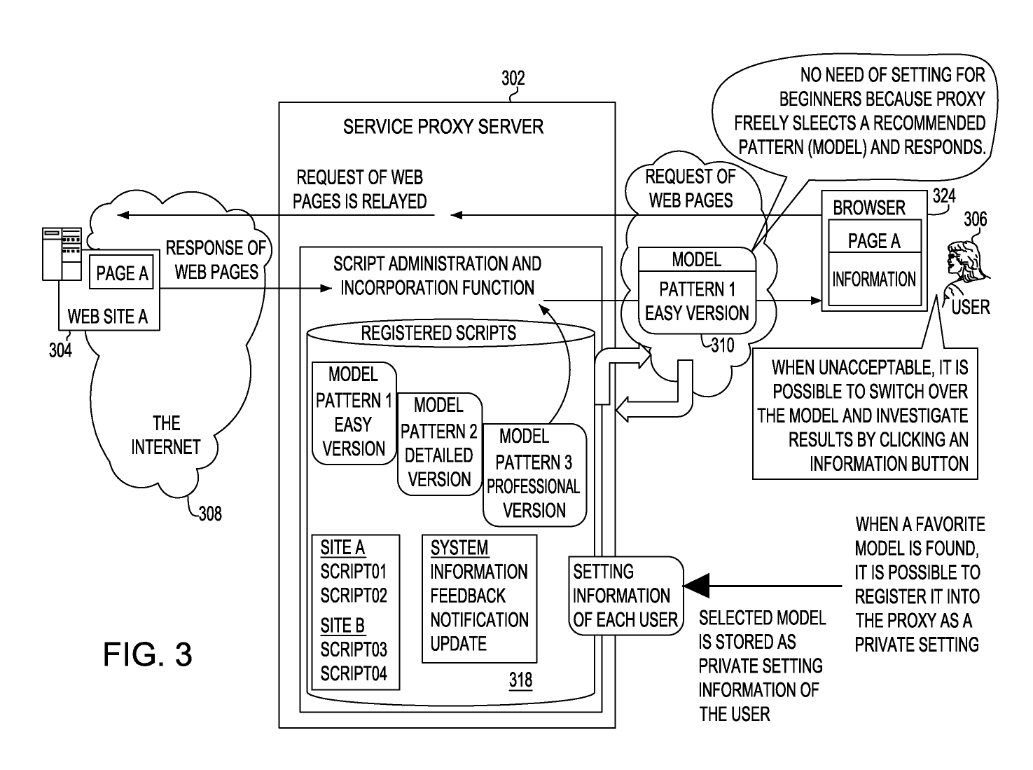

FIG. 3 illustrates applying user scripts automatically and/or selecting user scripts. The user 306 requests a web page and the proxy server 302 relays the web page request to the appropriate web site 304 via the Internet 308. The web site 304 responds with the web page. The proxy server 302 receives the web page and incorporates user scripts 318 according to a model that has been selected as private setting for the user. If the user has not yet selected a model for the requested web page, the proxy server may automatically incorporate the user scripts 318 of the suitable model based on the user preference, attribute, etc. A model may include one or more user scripts. In addition to the user scripts represented by a model, the proxy server also may incorporate the “information” user script, which shows all of the models and enables users to try and register one or more models as private or preferred user setting, if the user desires. The web page with incorporated scripts 310 are then transmitted to the user 306. In the rendered web page 324, the user 306 is presented with the original web content as returned from the web site 304 and the information resulting from the added script. If the returned web page 324 is not what the user wanted, the user may request to change the script or model, for instance, by selecting an appropriate functionality on the web page.

The user may select to try a model (i.e., one or more user scripts in the model). For instance, the user may select a model on the web page (e.g., as presented by the “information” user script described above) by pressing or selecting a button icon to try it. In response, the script receiving the selection sends a request to the proxy server via the browser. The proxy server then returns a web page incorporating the selected model into the original web page. When the desired model is found, the user may register it into the proxy server 302 as a private or preferred setting for the user, for instance, by selecting a register button provided by the “information” user script. The model represents a set of user scripts. By the functionality of the “information” user script, the user can try and see how the original web page is changed by the selected model.

The proxy server 302 administers the selected user scripts by each user and classifies that information into the models, based on the user's preference (e.g., which web site the user likes, or which user scripts the user uses, etc.) and user's skill level to maintain the user scripts. If the user has not yet selected the model for the requested web page, the proxy server may automatically incorporate the user scripts of the suitable model. Users can experience processing of pages by other models by selecting a button for displaying a model summary (e.g., offered function via Information script shown in FIG. 2B) and can register switchover to a favorite model.

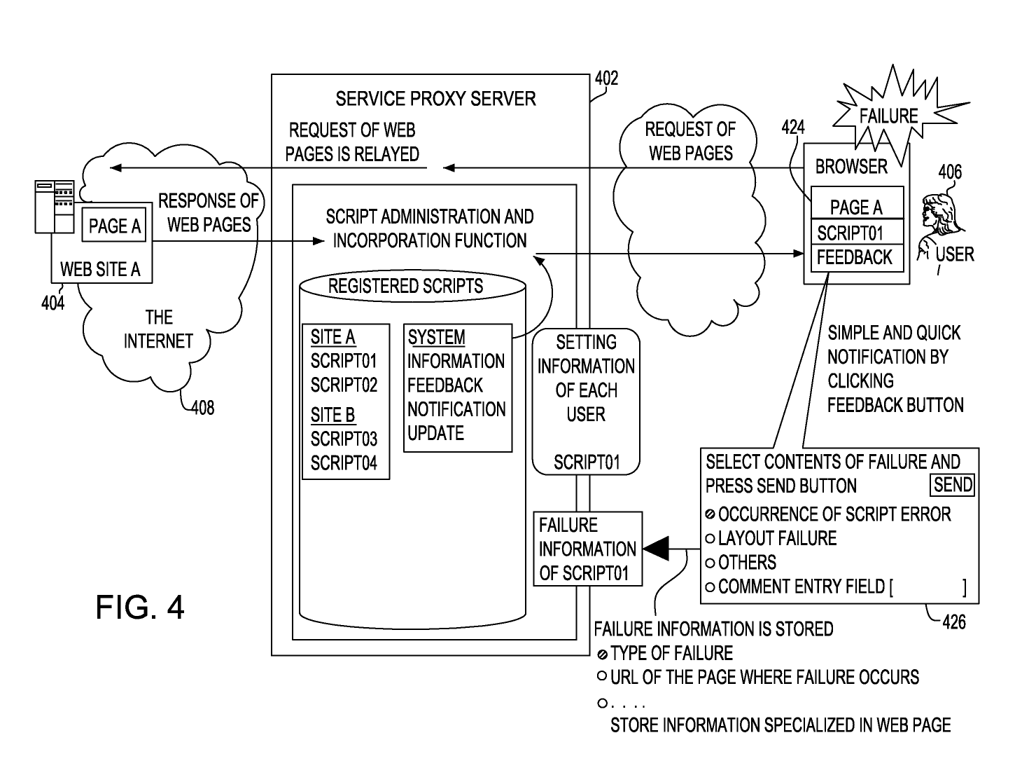

FIG. 4 is a diagram illustrating processing of feedback of failure from users. The user 406 requests a web page and the proxy server 402 relays the request to the appropriate web site 404 via the Internet 408. The web site 404 responds with the requested web page and the proxy server 402 incorporates its scripts, for instance, according to user private settings, and responds to the user with the modified web page 424. When a failure of the incorporated user scripts occurs in the browser at the user, users enable failure information to be reported using a failure information panel (e.g., offered by Feedback scripts shown in FIG. 2A and incorporated into the web page 424 automatically by the proxy server 402) on the web page. The feedback script may present a panel 426 to the user for selecting, describing and notifying the failures to the proxy server 402. The proxy server 402 stores the information related to the failure such as the URL of the web page that failed, type of failure, etc. that the user reports.

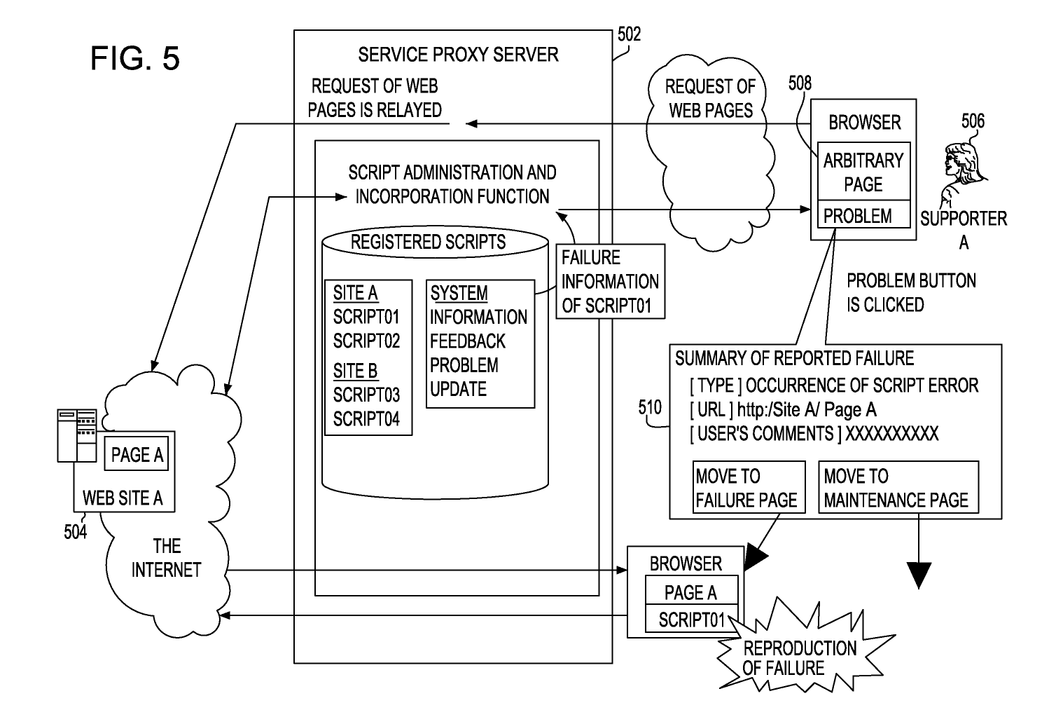

FIG. 5 is a diagram illustrating notification process for occurrence of failure to supporters in one embodiment of the present disclosure. In case failure is reported by users about a web site (e.g., 504), a failure information panel 510 is displayed to in response to the supporter 506 accessing that site (e.g., 504). For instance, the proxy server 502 may keep a list of users and their roles, and determines the user accessing a site is a supporter of that site by automatically performing look ups and matching. Further, the proxy server 502 determines whether that web site 504 being accessed by the supporter has been reported with failures. If the web page was reported with failure, the proxy server automatically incorporates a “problem” script in the web page requested by the supporter and returns it 508 to the browser of supporter 506.

This information panel 510 may be presented automatically by a “problem” script incorporated by the proxy server 502. The proxy server 502 automatically matches up the problem information and incorporates the “problem” script in response to a “supporter” 506 who maintains the site accessing the site. The problem of the user script may be notified to all the supporters who have ever maintained it.

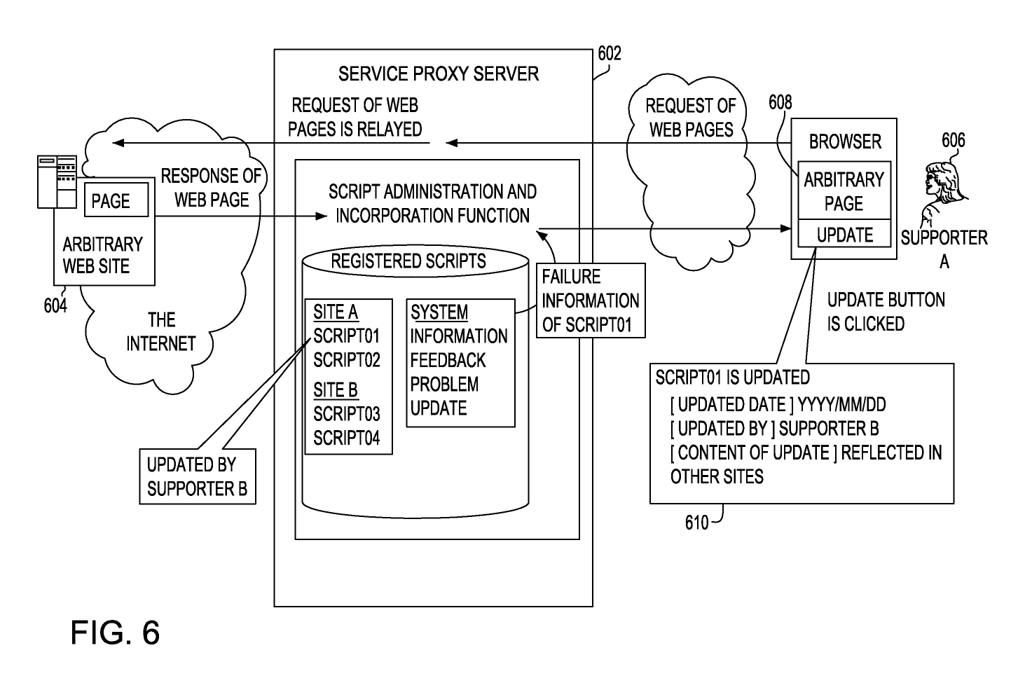

FIG. 6 is a diagram illustrating notification process for updated information to supporters in one embodiment of the present disclosure. Updating of scripts and setting information is notified to supporters by an update information panel, for instance, offered by Update script stored in the proxy server 602 and incorporated into user requested web page 608. Supporter is a user who has changed or changes, or maintained or maintains the user script. The proxy server 602 may distinguish or determine a user as being a “supporter” 606 from general users by using role information, for example, stored in the proxy server. For instance, if a user changed and/or maintained the specific user script previously, the proxy server manages the user as supporter of the user script that the user changed/maintained. Whichever web page 608 from a web site 604 the supporter may access, the proxy server 602 by recognizing the supporter as such notifies the supporter when the user script is updated, for instance, by incorporating an update script into the web page 608. The update script presents the update information 610 on the user browser.

FIG. 7 is a diagram illustrating information administered by the proxy server in one embodiment of the present disclosure. The role information 702 keeps information about the user's roles, for example, general user, supporter, etc. For instance, a user that develops, changes, and/or maintains scripts may be categorized as being a supporter or having a supporter role. When accessing via a proxy, different scripts are incorporated based on role information of users. The web pages information 704 includes URLs and update status of the web pages to which user scripts are applied. Registered scripts 706 includes user scripts for achieving added value and scripts having a function as a tool for supporting activities of users and supporters, and others. Application conditions of scripts 708 may include logic (e.g., executable logic) to decide whether the proxy server should incorporate scripts stored in registered scripts 706 into a web page. Application conditions of scripts 708 may also include a threshold value used in the logic; a threshold value common to all users and supporters (Web pages and external information); a threshold value common only to users and supporters of a certain group (community); and/or a threshold value associated with each user and supporter (e.g., personalized information). Criterion of script execution conditions 710 may include a threshold value which is incorporated into the user script by the proxy server and is used as an execution condition at the time the user script is executed on the web browser. The script administration and incorporation functionalities shown in FIG. 7 may reside in multiple files or modules, for example, as shown, or in a single file or module.

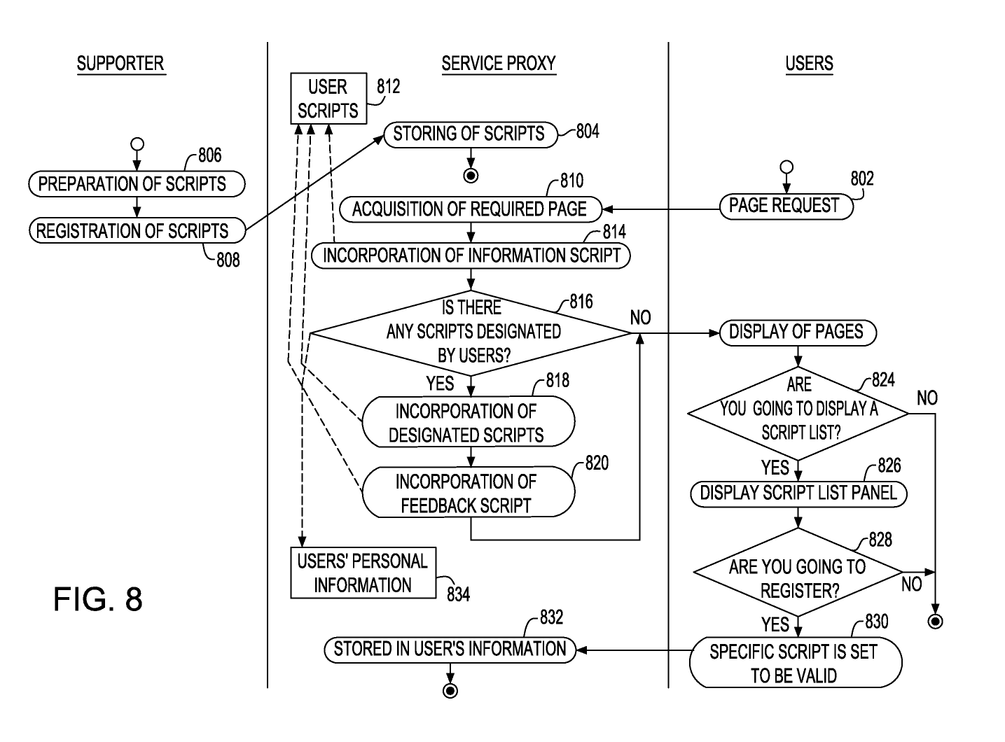

FIG. 8 is a flow diagram illustrating a method for registering user scripts. A service proxy or proxy service may be implemented as a computer server or like that services users' requests for web documents from various web sites, for example, designated by URLs. The service proxy may store (locally or remotely) various user scripts as shown at 804. The scripts, for example, are prepared by supporters or more experienced users or programmers who are familiar with script programming as shown at 806, and registered in the service proxy as shown at 808. Scripts 812 are stored for the service proxy to access. Scripts 812 may be store locally with the service proxy or remotely, for example, on another device such as a file server, database server, network file server, etc., but not limited to those.

At 802, a user sends a request for a document, for example, a web page from a web site by requesting a URL address. At 810, a service proxy, for example, a server implementing disclosed methods, receives the request for the document (e.g., web page or content from the URL) from the user, and acquires the document from the appropriate site, e.g., web page from that URL. At 814, the proxy may incorporate the information script, for example, depending on the user's role and/or private or preference settings and/or other criteria. At 816, the service proxy determines whether the user designated any other scripts to incorporate into the requested document or web page. This may be determined by looking up information 834 stored that is associated with the requesting user. If other scripts are to be incorporated, at 818, designated scripts are included into the web page appropriately. At 820, feedback script may be incorporated into the web page, for example, based on the user settings or other criteria. The requested document or web page with the incorporated scripts is then sent to the user. At 822, the page is presented to the user, for example, displayed on the user's computer monitor or like. At 824, it is determined whether a script list is to be presented also, for example, based on the user requesting a list of scripts to try. If yes, the script list is presented at 826. At 828, it is determined whether a script (e.g., the script that the user tried and likes) is to be registered, for example, based on user input or selection. If the script is to be registered, this information is stored at the service proxy as shown at 832. It should be noted that the actual storage of information may occur on a device that is local or remote to the service proxy.

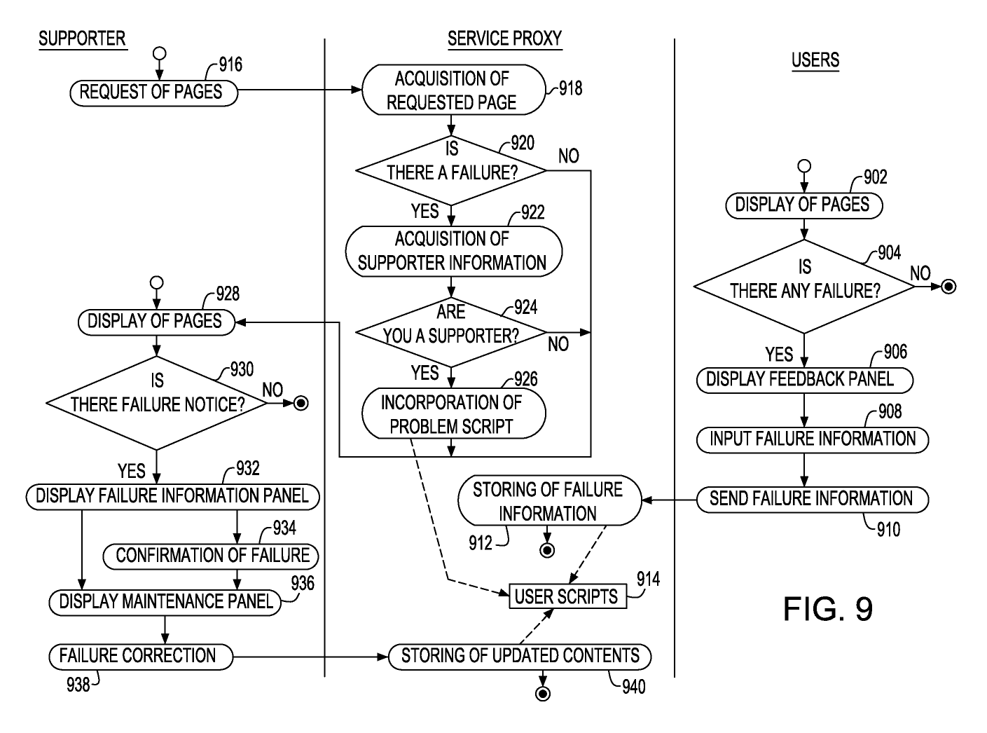

FIG. 9 is a flow diagram illustrating processing failures in user scripts. At 902, a web page or like document is displayed or otherwise presented to the user. At 904, it is determined whether any error or failure occurred on the web page, for example, in displaying or presenting the page, in accepting input from the user, etc. The failure may be detected automatically by the browser or like executing the script or by any other method. In another aspect, the failure may be reported manually by the user. At 906, feedback script displays or presents feedback panel that prompts the user to enter information related to the occurrence of the failure. At 908, the user enters the information. At 910, the entered information and any other information about the user computer that the feedback script may gather are sent to the service proxy. For instance, the feedback scrip via the browser may send the information back to the proxy. At 912, the service proxy stores the received information.

A supporter or an experienced user who may author and/or manage the scripts 914 requests a page at 916. This may happen asynchronously or independent of a user accessing the web page at 902. At 918, the service proxy retrieves the requested page from the appropriate location, e.g., the requested page's URL. At 920, it is determined whether there is failure in the web page, for example, by determining whether any users reported failure of a script running on this web page previously as described above. If not, the processing continues to 928. At 922, if there is a failure, supporter information is acquired, for example, by looking up the role information associated with the user at 916. At 924, it is determined whether the requesting user is a supporter. If not, the processing continues to 928. At 926, if the requesting person is a supporter, information received from the user previously relating to the failure of the same web page is retrieved and incorporated into the web page being returned to the support at 928.

At 928, the page is displayed or presented. At 930, if there is a failure on the page, then at 932, failure information panel is displayed or presented. At 934, failure confirmation occurs, e.g., by the supporter who also runs the web page and the script that failed. At 936, maintenance panel is displayed. At 93 8, the failure is corrected, for example, by the supporter by recoding the debugging of the script. At 940, the service proxy receives the corrected or updated user script and stores it 914. As explained above, the failure information panel, maintenance panel, and other panels are presented to the supporter by the corresponding or appropriate scripts. Those scripts were incorporated into the supporter requested web page by the proxy.

The system and method of the present disclosure not only provide solutions to the end users but also to the proxy service providers. For instance, the proxy can gather traffic information related to web accesses and also profile data related to users and web sites, which may be useful in handling clusters of users or people as characterized communities. Those information may be valuable in marketing as well as in navigating traffic for the users easily and more conveniently. The solution by service proxy as disclosed in the present disclosure may take advantage of huge amount of usages, results, profiled data to provide higher quality and more flexible supports by open source communities.

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium, upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

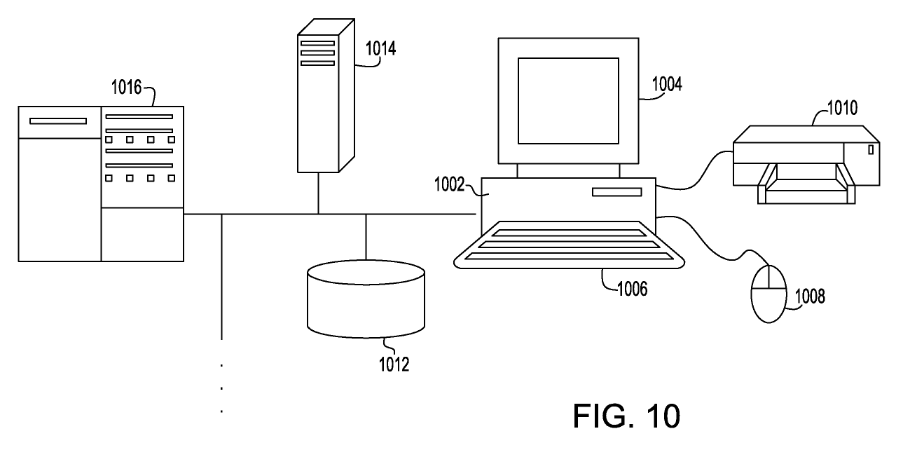

Referring now to FIG. 10, the systems and methodologies of the present disclosure may be carried out or executed in a computer system that includes a processing unit 1002, which houses one or more processors and/or cores, memory and other systems components (not shown expressly in the drawing) that implement a computer processing system, or computer that may execute a computer program product. The computer program product may comprise media, for example a hard disk, a compact storage medium such as a compact disc, or other storage devices, which may be read by the processing unit 1002 by any techniques known or will be known to the skilled artisan for providing the computer program product to the processing system for execution.

The computer program product may comprise all the respective features enabling the implementation of the methodology described herein, and which—when loaded in a computer system—is able to carry out the methods. Computer program, software program, program, or software, in the present context means any expression, in any language, code or notation, of a set of instructions intended to cause a system having an information processing capability to perform a particular function either directly or after either or both of the following: (a) conversion to another language, code or notation; and/or (b) reproduction in a different material form.

The computer processing system that carries out the system and method of the present disclosure may also include a display device such as a monitor or display screen 1004 for presenting output displays and providing a display through which the user may input data and interact with the processing system, for instance, in cooperation with input devices such as the keyboard 1006 and mouse device 1008 or pointing device. The computer processing system may be also connected or coupled to one or more peripheral devices such as the printer 1010, scanner (not shown), speaker, and any other devices, directly or via remote connections. The computer processing system may be connected or coupled to one or more other processing systems such as a server 1016, other remote computer processing system 1014, network storage devices 1012, via any one or more of a local Ethernet, WAN connection, Internet, etc. or via any other networking methodologies that connect different computing systems and allow them to communicate with one another. The various functionalities and modules of the systems and methods of the present disclosure may be implemented or carried out distributedly on different processing systems (e.g., 1002, 1014, 1016), or on any single platform, for instance, accessing data stored locally or distributedly on the network.

While not limited to the shown configuration, as an example, the user with a user role or supporter role or any other role may use the processing unit at 1002 to request a web page from a web server, for example, implemented at a system 1014, via a server at 1016, which may implement the services of proxy server of the present disclosure. The proxy server at 1016 may utilize local storage or remote storage 1012 to store various data in connection to providing and/or performing the methodologies of the present disclosure.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements, if any, in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Various aspects of the present disclosure may be embodied as a program, software, or computer instructions embodied in a computer or machine usable or readable medium, which causes the computer or machine to perform the steps of the method when executed on the computer, processor, and/or machine. A program storage device readable by a machine, tangibly embodying a program of instructions executable by the machine to perform various functionalities and methods described in the present disclosure is also provided.

The system and method of the present disclosure may be implemented and run on a general-purpose computer or special-purpose computer system. The computer system may be any type of known or will be known systems and may typically include a processor, memory device, a storage device, input/output devices, internal buses, and/or a communications interface for communicating with other computer systems in conjunction with communication hardware and software, etc.

The terms “computer system” and “computer network” as may be used in the present application may include a variety of combinations of fixed and/or portable computer hardware, software, peripherals, and storage devices. The computer system may include a plurality of individual components that are networked or otherwise linked to perform collaboratively, or may include one or more stand-alone components. The hardware and software components of the computer system of the present application may include and may be included within fixed and portable devices such as desktop, laptop, server. A module may be a component of a device software, program, or system that implements some “functionality”, which can be embodied as software, hardware, firmware, electronic circuitry, or etc.

The embodiments described above are illustrative examples and it should not be construed that the present invention is limited to these particular embodiments. Thus, various changes and modifications may be effected by one skilled in the art without departing from the spirit or scope of the invention as defined in the appended claims.

We claim:

1. A computer-implemented method for social user script service by service proxy, comprising:
storing a plurality of user scripts;
receiving a request from a user for an electronic document;
selecting based on one or more criteria one or more user scripts from the plurality of user scripts and one or more conditions under which said one or more user scripts are executed;
embedding said one or more selected user scripts into a requested electronic document; and
transmitting the requested electronic document with the embedded user scripts to the user.

2. The method of claim 1, wherein the user scripts include scripts for performing a predetermined functionality.

3. The method of claim 1, wherein the user scripts include at least information script, feedback script, or failure script or combination thereof.

4. The method of claim 1, wherein said one or more criteria include role of the user and whether the user registered the one or more scripts.

5. The method of claim 1, further including:
requesting and receiving said electronic document from a third party location.

6. The method of claim 1, wherein the electronic document is a web page.

7. The method of claim 1, wherein the selecting further includes looking up registration information associated with the user and selecting one or more scripts that the user registered.

8. The method of claim 1, further including:
receiving failure information related to the embedded user scripts from the user; and
storing the failure information.

9. The method of claim 8, further including:
receiving updates to one or more user scripts based on the failure information; and
storing the updates.

10. A system for social user script service by service proxy, comprising:
a storage device storing a plurality of user scripts and user registration information;
a service proxy processor operable to receive a request from a user for an electronic document and to selecting one or more user scripts from the plurality of user scripts based on the user registration information, the service proxy processor further operable to embed said one or more selected user scripts into a requested electronic document and transmit the requested electronic document with the embedded user scripts to the user.

11. The system of claim 10, wherein each of the user scripts is for performing a predetermined functionality.

12. The system of claim 10, wherein the user scripts include at least information script, feedback script, failure script.

13. The system of claim 10, wherein said user registration information include role of the user and whether the user registered the one or more scripts.

14. The system of claim 10, wherein the proxy server processor is further operable to request and receive said electronic document from a third party location.

15. The system of claim 10, wherein the electronic document is a web page.

16. The system of claim 10, wherein the proxy server processor looks up registration information associated with the user and selects one or more scripts that the user is registered for, and conditional criteria for executing said one or more scripts.

17. The system of claim 10, wherein the proxy server processor receives failure information related to the embedded user scripts from the user and stores the failure information.

18. A program storage device readable by a machine, tangibly embodying a program of instructions executable by the machine to perform a method of social user script service by service proxy, comprising:
storing a plurality of user scripts;
receiving a request from a user for an electronic document;
selecting based on one or more criteria one or more user scripts from the plurality of user scripts and one or more conditions under which said one or more user scripts are executed;
embedding said one or more selected user scripts into a requested electronic document; and
transmitting the requested electronic document with the embedded user scripts to the user.

19. The program storage device of claim 18, wherein the user scripts include scripts for performing a predetermined functionality.

20. The program storage device of claim 18, wherein said one or more criteria include role of the user and whether the user registered the one or more scripts.
